(19) United States
(12) Patent Application Publication
(10) Pub. No.: US 2015/0043224 A1
(43) Pub. Date: Feb. 12, 2015

(54) Water-Proof Structure For LED Recessed Lighting Device

(71) Applicant: Michael CHEN, Whittier, CA (US)

(72) Inventor: Michael CHEN, Whittier, CA (US)

(21) Appl. No.: 14/160,262

(22) Filed: Jan. 21, 2014

Related U.S. Application Data
(63) Continuation-in-part of application No. 13/960,956, filed on Aug. 7, 2013.

(51) Int. Cl. F21V 21/04; F21K 99/00

(52) U.S. Cl. CPC F21V 21/049; F21K 9/30
USPC 362/365

(57) ABSTRACT

Present invention teaches the construction of a LED lighting device where water-proof structure can be implemented to prevent water from coming into contact with the LED modules that are housed inside the device; accumulated water inside the groove/channel area will flow out, via the hole(s), and through the ring of ledge area of the light diffuser cover and drip down and away from the lighting device.

### RELATIONSHIP TO A PRIOR APPLICATION

This application is a Continuation-In-Part (CIP) application, under 37 CFR 1.53(b), of a prior parent application #13/960,956, by the same inventor(s), to supplement the disclosure matter related to the prior application. Present CIP application claims priority of the filing date of Aug. 7, 2013, per the requirements of 35 U.S.C. §120 and 37 C.F.R. 1.78.

### FIELD AND BACKGROUND OF THE INVENTION

Recessed lighting, usually installed on the ceiling or into walls at a spot elevated from ground level, has been on the market for a long time. The common and prevalent way of installing recessed lighting is to cut into ceiling or walls, form an empty cavity, put in a metal “can” or “bucket” with wiring connection points or terminals, and install lights to the can or the bucket.

With the advent LED recessed lighting, the ability to have a more compact light fixture installation is greatly enhanced, resulting in more prevalent use of LED recessed lighting devices in smaller spaces, such as the bathrooms.

Such use creates an issue of LED light coming to contact with water, mainly by accidental causes of spraying or mis-directing water usage of shower head or other gadgets, due to the small space nature of being installed in bathrooms.

If the water contact happens, there is always the safety concern of causing short circuit and the ensuing danger of other hazards that may come along with the short circuit.

Present invention provides a simple solution to such water issue, by the water-proofing structure disclosed and claimed herein.

### OBJECTS AND SUMMARY OF THE INVENTION

The present invention relates generally to recessed lighting devices containing LED light modules. Particularly, present invention reduces chance of the electrical short-circuit hazard caused by accidental water spray or leakage that may happen inside bathrooms.

A diffuser cover serves soften the light and to protect the LED light module from any direct water spraying that may come in contact with the LED module or any circuitry.

A ring pad will be snuggly fitted to the open area of a groove around the outer perimeter of the receiving tray. The material of the ring pad can be any resin, polyester, plastic or rubber that is generally impervious to water seepage and prevent water from coming into the groove, when said ring pad is fitted. To the extent some water comes into the groove, the shape of the groove will allow any water to trickle downward and flow through the holes, towards the ring of ledge area formed from the ring of lip on the diffuser cover, preventing water from reaching to the LED light module.

The water on the ledge area will then flow outwards from the ledge area and downward.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the two major components: diffuser cover and the receiving tray. A locking tab is shown in the diffuser cover; corresponding tab holes are shown on the receiving tray. Some LED light modules, not part of the claimed invention, are shown attached to the generally flat area of the receiving tray.

FIG. 2 shows the back side of the receiving tray. A sample LED light module controller circuit, in a box-like structure, is shown. Said controller circuit is not part of the claimed invention herein.

FIG. 3 shows the side view of an assembled product pursuant to present disclosure.

FIG. 4 shows the disabled view of the components.

FIG. 5 shows the cut-away perspective view of the water-proofing structure disclosed herein.

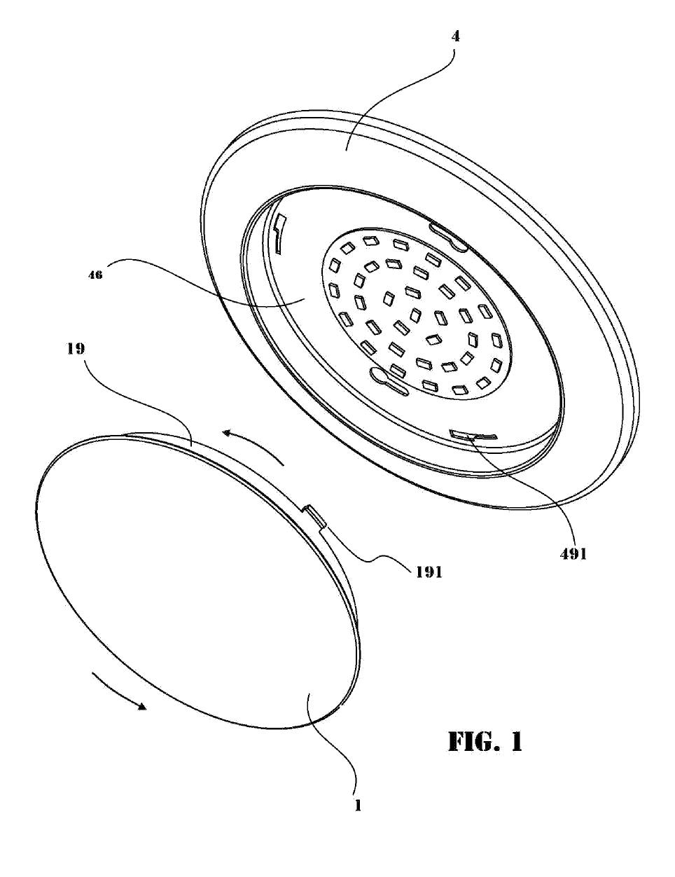

### DETAILED DESCRIPTION OF THE PREFERRED EMBODIMENT

As shown in the figures, the water-proof structure for the LED recessed light device 100 generally has two major portions: a receiving tray 4 and a diffuser cover 1.

The receiving tray 4 has a front side 46 and a back side 47.

The front side 46 has a generally flat area for housing LED lighting modules.

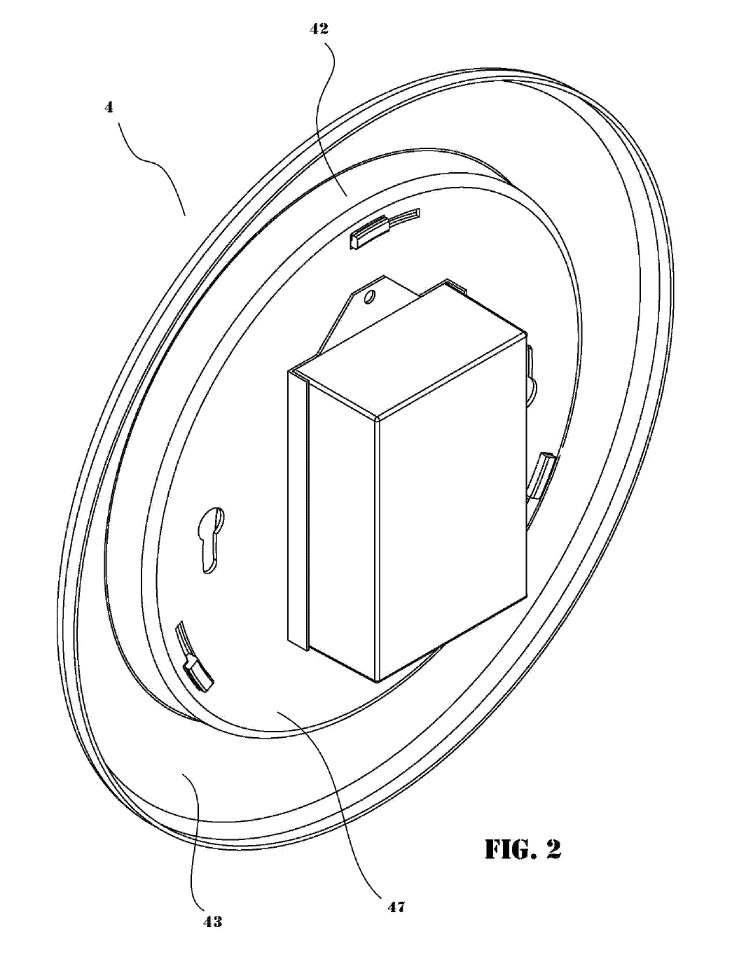

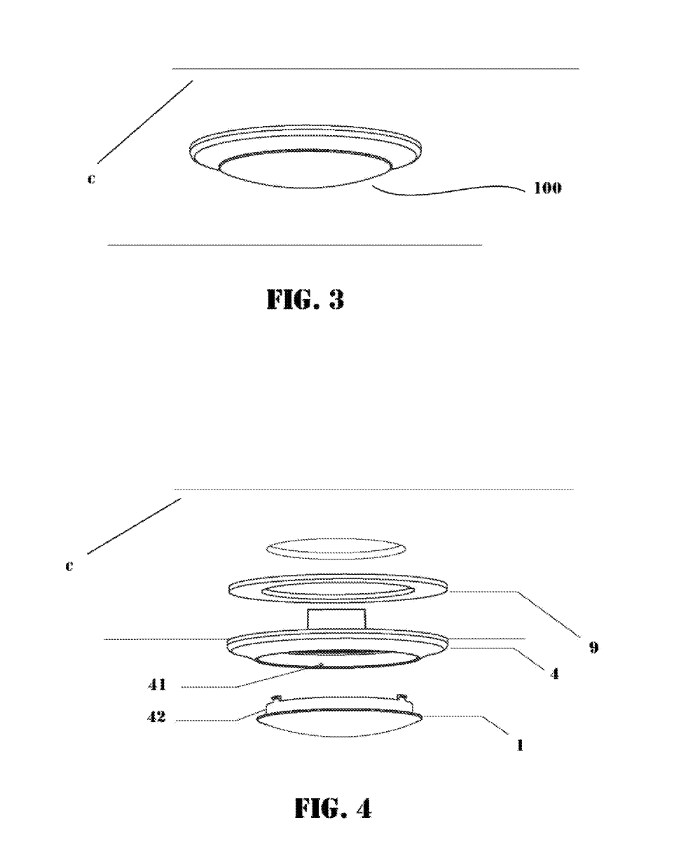

The back side 47, as shown in FIG. 2, has a groove 43 formed along the perimeter of said receiving tray 4.

A ring of groove wall 42 generally defines the flat area for the front side 46, to house the LED light module.

At least a hole 41 is formed on said groove wall 42, so as to allow water accumulated in the “channel” inside the groove 43 to flow out to the ledge area (18, explained later) on the diffuser cover.

In actual implementation, there can be more than one holes 41 and preferably evenly spaced around said groove wall 42.

A ring pad 9 is fitted snugly over the open side of said groove 43, so as to cover up the round “channel” area form by the groove 43. The ring pad 9 can be made from any flexible material that's generally impervious to water.

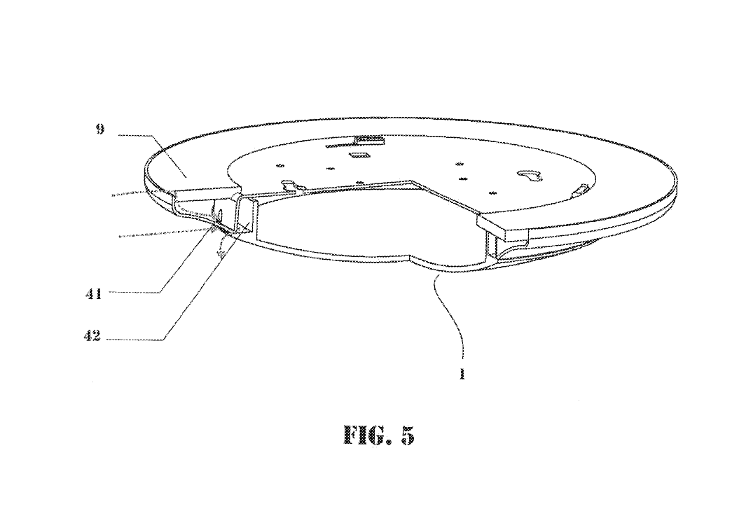

The diffuser cover 1 has a ring of lip 19, with a small position offset inward from the outer perimeter of the edge of said diffuser cover, forming a ring of ledge area 18, as shown in FIG. 5.

A few locking tabs 191 are formed on the top side of said ring of lip 19, so as to “click in” to corresponding tab holes 491 on the said receiving tray 4, when the diffuser cover 1 is installed to the receiving tray 4.

When a LED lighting device with the water-proof structure of present invention is fully assembled and installed, the ring pad will generally prevent water from coming into the groove 43 of the lighting device.

In case some water does come in to the groove 43 area, the hole(s) 41 on the wall 42 of the groove 43 will cause the water to leak out, on the ring of ledge area 18 of the light diffuser cover 1, so as to prevent the LED lighting module from coming into contact with water, causing the short-circuit to happen.

What is claimed is:

1. A water-proof structure for LED recessed lighting device, comprising:
a. A receiving tray having a front side and a back side, wherein said front side has a generally flat area to house LED lighting modules and said back side has a ring of groove formed around the outer perimeter of said receiving tray, said groove further having a ring of wall with at least one hole;
b. a ring pad for snug-fitting on to the opening of said groove; and,
c. a light diffuser cover for fitting to the front side of said receiving tray, wherein said light diffuser cover has a ring of lip with a small position offset inward from the outer perimeter of said diffuser cover, forming a ring of ledge area.

2. The water-proof structure of claim 1, wherein a plurality of holes are formed on the ring of wall.

3. The water-proof structure of claim 2, where the a plurality of holes are evenly spaced.

4. The water-proof structure of claim 1, further comprising a plurality of locking tabs on the top side of said ring of wall, for clicking into corresponding tab holes on the generally flat area of said receiving tray.
